(19) United States
(12) Patent Application Publication
(10) Pub. No.: US 2013/0211004 A1
(43) Pub. Date: Aug. 15, 2013

(54) LIQUID REPELLENT SURFACES

(71) Applicant: Stephen Coulson, Abingdon (GB)

(72) Inventor: Stephen Coulson, Abingdon (GB)

(73) Assignee: P2I LIMITED, Abingdon (GB)

(21) Appl. No.: 13/522,231

(22) PCT Filed: Jan. 10, 2011
(86) PCT No.: PCT/GB11/50025

§ 371 Date: Jan. 14, 2013

(30) Foreign Application Priority Data
Jan. 14, 2010 (GB) 1000538.7

(51) Int. Cl. B05D 1/00

(52) U.S. Cl. CPC B05D 1/62
USPC 524/780; 427/569

(57) ABSTRACT

A method for forming a liquid repellent surface on a substrate, said method comprising applying a combination of nanoparticles and a polymeric material to the surface in a chamber using ionisation or activation technology, in particular plasma processing.

The present invention relates to substrates and articles having liquid repellent surfaces, as well as methods for producing such surfaces.

Plastic products such as electrical casings, product housings and bio-consumable devices are well known and are generally obtained by moulding a hot polymer melt in order to form complex 3D structures. Moulding techniques include injection moulding as well as compression, transfer, extrusion, co-extrusion, blow, rotational and thermoforming (such as vacuum forming, reaction injection etc.) moulding. These techniques produce products with good mechanical properties. Furthermore, consistent product tolerances can be obtained repeatedly, in a rapid process lasting just a few seconds.

The polymers used in these processes are generally chosen on the basis of their bulk physical properties such as glass transition temperature, Young's modulus and flow characteristics which are a requirement for injection moulding, or for the bulk physical properties of the resulting product such as heat resistance, flexibility, toughness or optical clarity.

This means that the resulting surface properties of the moulded items may not be ideal for the function, despite the fact that surface interactions may, in practice, dictate or dominate their use. For example, in bio-consumable applications where there is a need to resist the interaction of liquids either for filtration, storage or transfer, surface properties such as surface wetting is very important. Although inherently hydrophobic materials, for example polypropylene, can be used, even these may have disadvantages. In particular, although they show good levels of repellency to water and predominantly high percentage volume aqueous solutions, many liquids used in the laboratory, clinical R&D labs and for drug synthesis are organic in nature and do wet such surfaces. As a result, high liquid retention on the substrate, for example the filtration media or receptacle is observed which is highly undesirable.

The industries concerned have often turned to chemical methods for addressing this issue. For example, in some cases, suitable chemical additives may be included in the polymer to modify the surface properties, or coatings having more desirable properties applied, for example by dipping or by the use of techniques such as plasma enhanced chemical vapour deposition. However, there may be disadvantages associated with these methods. For example, additives may suffer from migration issues and leaching whilst coatings may be subject to pin-holes that reduce the liquid repellency.

Furthermore there is a need to provide enhanced repellency to a whole host of other materials such as fabrics, garments, footwear, membranes etc where the product would benefit from improved levels of liquid repellency.

Physical means have also been used to control surface properties to some extent. For instance, by ensuring the products are smooth at the micro level, for example by ensuring that moulds used to produce the products are meticulously diamond polished, wettability of the final surface may be reduced. Although the diamond polished method can show advantages for certain liquids being used, the vast majority of low surface tension liquids will still adhere and wet-out on materials such as polypropylene.

In addition to altering the surface chemistry, changes in the surface roughness can also be used to create low surface energy materials and therefore produce low retention products. For example, it is known that surface roughness can affect liquid repellency in certain substrates such as stone (see for example, Manoudis et al., Journal of Physics: Conference Series 61 (2007) 1361-1365). Surface roughness may be controlled by inclusion of nanoparticles, for example of silicone, silica or polymeric substances into the surface. Polymeric nanoparticles formulations have been used also to produce microbe repellent coatings (see EP-A-1371690).

The nanoparticles are generally applied in combination with polymeric substances using conventional coating techniques such as spraying or dipping to form composite surfaces.

Plasma deposition techniques have been quite widely used for the deposition of polymeric coatings onto a range of surfaces, and in particular onto fabric surfaces. This technique is recognised as being a clean, dry technique that generates little waste compared to conventional wet chemical methods. Using this method, plasmas are generated from organic molecules, which are subjected to an electrical field. When this is done in the presence of a substrate, the radicals of the compound in the plasma polymerise on the substrate. Conventional polymer synthesis tends to produce structures containing repeat units that bear a strong resemblance to the monomer species, whereas a polymer network generated using a plasma can be extremely complex. The properties of the resultant coating can depend upon the nature of the substrate as well as the nature of the monomer used and conditions under which it is deposited. However, techniques described for example in WO 2007/083121, WO 2007/083122, WO 2007/083124 and WO2008053150 have been found to produce highly liquid repellent surfaces on various substrates.

Highly water repellent surfaces on fabrics obtained by condensing silicone gas onto the surface of the fabric so as to coat the fibres with spiky filaments of silicone have recently been reported. However, the wash and abrasion resistance of such coatings are not high.

The applicants have found a controllable way of producing highly liquid repellent surfaces on a wide range of substrates.

According to the present invention there is provided a method for forming a liquid repellent surface on a substrate, said method comprising applying a combination of nanoparticles and a polymeric material to the surface in a chamber using ionisation or activation technology such as plasma processing.

The use of ionisation or activation technology such as plasma processing to produce a composite nanoparticle/polymer surface is a highly controllable method that is able to produce surfaces having a high degree of liquid repellency or non-wetting properties cleanly and effectively. Furthermore, the surface layer becomes molecularly bound to the substrate and so there are no leachables; the modification becomes part of the substrate. The surfaces are therefore robust and may be resistant to washing.

Using the method of the invention, it is possible to introduce the nano-roughening of a surface during the vapour phase introduction, and therefore surfaces with specific properties, in particular high levels of liquid repellency may be achieved.

The nanoparticles may be applied to the surface within the chamber using various techniques including spraying, electro-deposition or sol-gel techniques. Once the nanoparticles are positioned on the surface, the polymeric material can be applied using ionisation or activation technology so as to form a very thin coating layer, adhering the nanoparticles to the surface. In particular however, the nanoparticles are deposited using the ionisation or activation technology that may be operated in the chamber. In particular, the nanoparticles are deposited using plasma processing. Depending upon the nature of the nanoparticles, they may be introduced into the chamber using for example a carrier gas stream, such as an inert gas as helium or argon. In other cases, for example in the case of metals or silicone, they may be evaporated to form nanoparticles on the surface using the ionisation or activation technology.

Alternatively the nanoparticles can be dispersed within the monomer and introduced into the chamber by evaporation or similar techniques.

In a further embodiment, both the nanoparticles and the polymeric material are co-deposited on the surface using ionisation or activation technology, such as plasma polymerisation. In such instances, nanoparticles may be included in the stream of monomer gas or carrier gas added for example to a plasma polymerisation chamber. In particular, the nanoparticles may be dispersed within the liquid monomer source or they may be fed into the stream of monomer gas as it enters the chamber. They are then carried through on the gas flow into the chamber. Generally there the particles will become deposited on the surface of the substrate together with the monomer. In some cases, depending upon the nature of the nanoparticles themselves, they may in fact evaporate or partially evaporate in the chamber and reform on the substrate surface, where they become part of the final coating. Any excess nanoparticle material will be flashed off with monomer.

Nanoparticles included in the surfaces may be of any convenient type. Their crystallinity and/or size may be selected to ensure that the desired surface roughness is achieved. The precise nature of the nanoparticles will depend upon factors such as the desired end use, compatibility the monomer and the ability to be introduced with the monomer. Thus suitable nanoparticles may include metal or metal compounds such as oxides, for example, silver, gold, palladium or titanium dioxide, silicone, silica, or polymeric nanoparticles for example as described in EP-A-1371690, the content of which is incorporated herein by reference.

Nanoparticles used may have a mean particle size or diameter for example of from 1 to 500 nm, such as from 1 to 100 nm, for example from 1 to 50 nm and in particular from 1 to 30 nm. For instance nanoparticles may have a mean particle size or diameter of from 50 to 100 nm. The size and shape of the nanoparticles will affect how they are able to pack together on the surface. Thus very small nanoparticles may pack into small crevices or pores in the surface and fill them, whereas larger particles may be more inclined to remain on the outer surface. Furthermore, spiky nanoparticles may have the effect of creating an ‘open’ structure that may be highly repellent to liquid such as water where the nanoparticles themselves comprise hydrophobic materials such as silicone.

Substrates treated in accordance with the invention retain their bulk properties as the coating layer deposited thereon is only molecules thick.

Any monomer that undergoes plasma polymerisation or modification of the surface to form a suitable polymeric coating layer or surface modification on the surface of the substrate may suitably be used to form the polymeric material of the surface. In particular, monomers that are known in the art to be capable of producing hydrophobic or oleophobic polymeric coatings on substrates are preferred as these are then able to enhance the effect of the nanoparticles themselves. Examples of such monomers include carbonaceous compounds having reactive functional groups, particularly substantially —CF₃ dominated perfluoro compounds (see WO 97/38801), perfluorinated alkenes (Wang et al., Chem Mater 1996, 2212-2214), hydrogen containing unsaturated compounds optionally containing halogen atoms or perhalogenated organic compounds of at least 10 carbon atoms (see WO 98/58117), organic compounds comprising two double bonds (WO 99/64662), saturated organic compounds having an optionally substituted alky chain of at least 5 carbon atoms optionally interposed with a heteroatom (WO 00/05000), optionally substituted alkynes (WO 00/20130), polyether substituted alkenes (U.S. Pat. No. 6,482,531B) and macrocycles containing at least one heteroatom (U.S. Pat. No. 6,329,024B), the contents of all of which are herein incorporated by reference.

A particular group of monomers which may be used in the method of the present invention include compounds of formula (I)

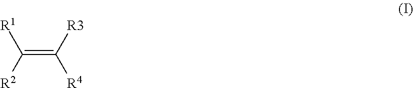

where R¹, R² and R³ are independently selected from hydrogen, halo, alkyl, haloalkyl or aryl optionally substituted by halo; and R⁴ is a group —X—R⁵ where R⁵ is halo, an alkyl or haloalkyl group and X is a bond; a group of formula —C(O)O—, a group of formula —C(O)O(CH₂)ₙY — where n is an integer of from 1 to 10 and Y is a sulphonamide group; or a group —(O)ₚR⁶(O)_{q}(CH₂)ₜ— where R⁶ is aryl optionally substituted by halo, p is 0 or 1, q is 0 or 1 and t is 0 or an integer of from 1 to 10, provided that where q is 1, t is other than 0; for a sufficient period of time to allow a polymeric layer to form on the surface.

As used therein the term “halo” or “halogen” refers to fluorine, chlorine, bromine and iodine. Particularly preferred halo groups are fluoro. The term “aryl” refers to aromatic cyclic groups such as phenyl or naphthyl, in particular phenyl. The term “alkyl” refers to straight or branched chains of carbon atoms, suitably of up to 20 carbon atoms in length. The term “alkenyl” refers to straight or branched unsaturated chains suitably having from 2 to 20 carbon atoms. “Haloalkyl” refers to alkyl chains as defined above which include at least one halo substituent.

Suitable haloalkyl groups for R¹, R², R³ and R⁵ are fluoroalkyl groups. The alkyl chains may be straight or branched and may include cyclic moieties.

For R⁵, the alkyl chains suitably comprise 2 or more carbon atoms, suitably from 2-20 carbon atoms and preferably from 4 to 12 carbon atoms.

For R¹, R² and R³, alkyl chains are generally preferred to have from 1 to 6 carbon atoms.

Preferably R⁵ is a haloalkyl, and more preferably a perhaloalkyl group, particularly a perfluoroalkyl group of formula CₘF₂ₘ₊₁ where m is an integer of 1 or more, suitably from 1-20, and preferably from 4-12 such as 4, 6 or 8.

Suitable alkyl groups for R¹, R² and R³ have from 1 to 6 carbon atoms.

In one embodiment, at least one of R¹, R² and R³ is hydrogen. In a particular embodiment R¹, R², R³ are all hydrogen. In yet a further embodiment however R³ is an alkyl group such as methyl or propyl.

Where X is a group —C(O)O(CH₂)ₙY—, n is an integer which provides a suitable spacer group. In particular, n is from 1 to 5, preferably about 2.

Suitable sulphonamide groups for Y include those of formula —N(R⁷)SO₂⁻ where R⁷ is hydrogen or alkyl such as C₁₋₄alkyl, in particular methyl or ethyl.

In one embodiment, the compound of formula (I) is a compound of formula (II)

CH₂═CH—R⁴ (II)

where R⁴ is as defined above in relation to formula (I).

In compounds of formula (II), ‘X’ within the X—R⁵ group in formula (I) is a bond.

However in a preferred embodiment, the compound of formula (I) is an acrylate of formula (III)

CH₂═CR^{7a}C(O)O(CH₂)ₙR⁵ (III)

where n and R⁵ as defined above in relation to formula (I) and R^{7a} is hydrogen, C₁₋₁₀ alkyl, or C₁₋₁₀haloalkyl. In particular R^{7a} is hydrogen or C₁₋₆alkyl such as methyl. A particular example of a compound of formula (III) is a compound of formula (IV)

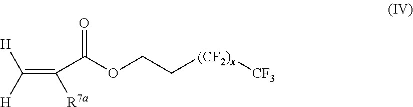

where R^{7a} is as defined above, and in particular is hydrogen and x is an integer of from 1 to 9, for instance from 4 to 9, and preferably 7. In that case, the compound of formula (IV) is 1H,1H,2H,2H-heptadecafluorodecylacylate.

According to a particular embodiment, the polymeric material on the surface is formed by exposing the substrate to plasma comprising one or more organic monomeric compounds, at least one of which comprises two carbon-carbon double bonds for a sufficient period of time to allow a polymeric layer to form on the surface.

Suitably the compound with more than one double bond comprises a compound of formula (V)

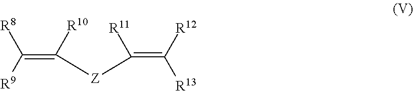

where R⁸, R⁹, R¹⁰, R¹¹, R¹², and R¹³ are all independently selected from hydrogen, halo, alkyl, haloalkyl or aryl optionally substituted by halo; and Z is a bridging group.

Examples of suitable bridging groups Z for use in the compound of formula (V) are those known in the polymer art. In particular they include optionally substituted alkyl groups which may be interposed with oxygen atoms. Suitable optional substituents for bridging groups Z include perhaloalkyl groups, in particular perfluoroalkyl groups.

In a particularly preferred embodiment, the bridging group Z includes one or more acyloxy or ester groups. In particular, the bridging group of formula Z is a group of sub-formula (VI)

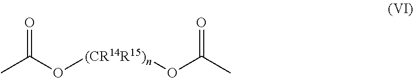

where n is an integer of from 1 to 10, suitably from 1 to 3, each R¹⁴ and R¹⁵ is independently selected from hydrogen, alkyl or haloalkyl.

Suitably R⁸, R⁹, R¹⁰, R¹¹, R¹², and R¹³ are haloalkyl such as fluoroalkyl, or hydrogen. In particular they are all hydrogen.

Suitably the compound of formula (V) contains at least one haloalkyl group, preferably a perhaloalkyl group.

Particular examples of compounds of formula (V) include the following:

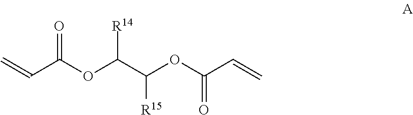

wherein R¹⁴ and R¹⁵ are as defined above and at least one of R¹⁴ or R¹⁵ is other than hydrogen. A particular example of such a compound is the compound of formula B.

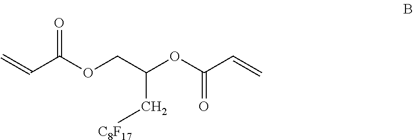

In a further embodiment, the polymeric material is formed on the surface by exposing the substrate to plasma comprising a monomeric saturated organic compound, said compound comprising an optionally substituted alkyl chain of at least 5 carbon atoms optionally interposed with a heteroatom for a sufficient period of time to allow a polymeric layer to form on the surface.

The term “saturated” as used herein means that the monomer does not contain multiple bonds (i.e. double or triple bonds) between two carbon atoms which are not part of an aromatic ring. The term “heteroatom” includes oxygen, sulphur, silicon or nitrogen atoms. Where the alkyl chain is interposed by a nitrogen atom, it will be substituted so as to form a secondary or tertiary amine. Similarly, silicons will be substituted appropriately, for example with two alkoxy groups.

Particularly suitable monomeric organic compounds are those of formula (VII)

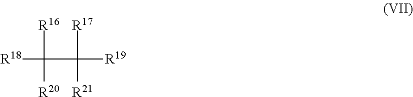

where R¹⁶, R¹⁷, R¹⁸, R¹⁹ and R²⁰ are independently selected from hydrogen, halogen, alkyl, haloalkyl or aryl optionally substituted by halo; and R²¹ is a group X—R²² where R²² is an alkyl or haloalkyl group and X is a bond or a group of formula —C(O)O(CH₂)ₓY— where x is an integer of from 1 to 10 and Y is a bond or a sulphonamide group; or a group —(O)ₚR²³(O)ₛ(CH₂)ₜ— where R²³ is aryl optionally substituted by halo, p is 0 or 1, s is 0 or 1 and t is 0 or an integer of from 1 to 10, provided that where s is 1, t is other than 0.

Suitable haloalkyl groups for R¹⁶, R¹⁷, R¹⁸, R¹⁹, and R²⁰ are fluoroalkyl groups. The alkyl chains may be straight or branched and may include cyclic moieties and have, for example from 1 to 6 carbon atoms.

For R²², the alkyl chains suitably comprise 1 or more carbon atoms, suitably from 1-20 carbon atoms and preferably from 6 to 12 carbon atoms.

Preferably R²² is a haloalkyl, and more preferably a perhaloalkyl group, particularly a perfluoroalkyl group of formula C_{z}F_{2z+1} where z is an integer of 1 or more, suitably from 1-20, and preferably from 6-12 such as 8 or 10.

Where X is a group —C(O)O(CH₂)_{y}Y—, y is an integer which provides a suitable spacer group. In particular, y is from 1 to 5, preferably about 2.

Suitable sulphonamide groups for Y include those of formula —N(R²³)SO₂⁻ where R²³ is hydrogen, alkyl or haloalkyl such as C₁₋₄alkyl, in particular methyl or ethyl.

The monomeric compounds used in the method of the invention preferably comprises a C₆₋₂₅ alkane optionally substituted by halogen, in particular a perhaloalkane, and especially a perfluoroalkane.

According to another aspect, the polymeric coating is formed by exposing the substrate to plasma comprising an optionally substituted alkyne for a sufficient period to allow a polymeric layer to form on the surface.

Suitably the alkyne compounds used in the method of the invention comprise chains of carbon atoms, including one or more carbon-carbon triple bonds. The chains may be optionally interposed with a heteroatom and may carry substituents including rings and other functional groups. Suitable chains, which may be straight or branched, have from 2 to 50 carbon atoms, more suitably from 6 to 18 carbon atoms. They may be present either in the monomer used as a starting material, or may be created in the monomer on application of the plasma, for example by the ring opening

Particularly suitable monomeric organic compounds are those of formula (VIII)

R²⁴—C≡X—X¹—R²⁵ (VIII)

where R²⁴ is hydrogen, alkyl, cycloalkyl, haloalkyl or aryl optionally substituted by halo; X¹ is a bond or a bridging group; and R²⁵ is an alkyl, cycloalkyl or aryl group optionally substituted by halogen.

Suitable bridging groups X¹ include groups of formulae —(CH₂)ₛ—, —CO₂(CH₂)ₚ—, —(CH₂)ₚO(CH₂)_{q}—, —(CH₂)ₚN(R²⁶)CH₂)_{q}—, —(CH₂)ₚN(R²⁶)SO₂—, where s is 0 or an integer of from 1 to 20, p and q are independently selected from integers of from 1 to 20; and R²⁶ is hydrogen, alkyl, cycloalkyl or aryl. Particular alkyl groups for R²⁶ include C₁₋₆ alkyl, in particular, methyl or ethyl.

Where R²⁴ is alkyl or haloalkyl, it is generally preferred to have from 1 to 6 carbon atoms.

Suitable haloalkyl groups for R²⁴ include fluoroalkyl groups. The alkyl chains may be straight or branched and may include cyclic moieties. Preferably however R²⁴ is hydrogen.

Preferably R²⁵ is a haloalkyl, and more preferably a perhaloalkyl group, particularly a perfluoroalkyl group of formula CᵣF₂ᵣ₊₁ where r is an integer of 1 or more, suitably from 1-20, and preferably from 6-12 such as 8 or 10.

In a particular embodiment, the compound of formula (VIII) is a compound of formula (IX)

CH≡C(CH₂)ₛ—R²⁷ (IX)

where s is as defined above and R²⁷ is haloalkyl, in particular a perhaloalkyl such as a C₆₋₁₂ perfluoro group like C₆F₁₃.

In another embodiment, the compound of formula (VIII) is a compound of formula (X)

CH≡C(O)O(CH₂)ₚR²⁷ (X)

where p is an integer of from 1 to 20, and R²⁷ is as defined above in relation to formula (IX) above, in particular, a group C₈F₁₇. Preferably in this case, p is an integer of from 1 to 6, most preferably about 2.

Other examples of compounds of formula (VIII) are compounds of formula (XI)

CH≡C(CH₂)ₚO(CH₂)_{q}R²⁷, (XI)

where p is as defined above, but in particular is 1, q is as defined above but in particular is 1, and R²⁷ is as defined in relation to formula (IX), in particular a group C6F₁₃;
or compounds of formula (XII)

CH≡C(CH₂)ₚN(R²⁶)(CH₂)_{q}R²⁷ (XII)

where p is as defined above, but in particular is 1, q is as defined above but in particular is 1, R²⁶ is as defined above an in particular is hydrogen, and R²⁷ is as defined in relation to formula (IX), in particular a group C₇F₁₅;

or compounds of formula (XIII)

CH≡C(CH₂)ₚN(R²⁶)SO₂R²⁷ (XIII)

where p is as defined above, but in particular is 1,R²⁶ is as defined above an in particular is ethyl, and R²⁷ is as defined in relation to formula (IX), in particular a group C₈F₁₇.

In an alternative embodiment, the alkyne monomer used in the process is a compound of formula (XIV)

R²⁸C≡C(CH₂)ₙSiR²⁹R³⁰R³¹ (XIV)

where R²⁸ is hydrogen, alkyl, cycloalkyl, haloalkyl or aryl optionally substituted by halo, R²⁹, R³⁰ and R³¹ are independently selected from alkyl or alkoxy, in particular C₁₋₆ alkyl or alkoxy.

Preferred groups R²⁸ are hydrogen or alkyl, in particular C₁₋₆ alkyl.

Preferred groups R²⁹, R³⁰ and R³¹ are C₁₋₆ alkoxy in particular ethoxy.

In general, the substrate to be treated is placed within a plasma chamber together with the monomer to be deposited in gaseous state (optionally in combination with the nanoparticles), a glow discharge is ignited within the chamber and a suitable voltage is applied, which may be pulsed.

The polymeric coating may be produced under both pulsed and continuous-wave plasma deposition conditions but pulsed plasma may be preferred as this allows closer control of the coating, and so the formation of a more uniform polymeric structure.

As used herein, the expression “in a gaseous state” refers to gases or vapours, either alone or in mixture, as well as aerosols.

Precise conditions under which the plasma polymerization takes place in an effective manner will vary depending upon factors such as the nature of the polymer, the substrate being treated including both the material from which it is made and the pore size etc. and will be determined using routine methods and/or the techniques.

Suitable plasmas for use in the method of the invention include non-equilibrium plasmas such as those generated by radiofrequencies (RF), microwaves or direct current (DC). They may operate at atmospheric or sub-atmospheric pressures as are known in the art. In particular however, they are generated by radiofrequencies (RF).

Various forms of equipment may be used to generate gaseous plasmas. Generally these comprise containers or plasma chambers in which plasmas may be generated. Particular examples of such equipment are described for instance in WO2005/089961 and WO02/28548, but many other conventional plasma generating apparatus are available.

The gas present within the plasma chamber may comprise a vapour of the monomer alone, but it may be combined with a carrier gas, in particular, an inert gas such as helium or argon, if required. In particular helium is a preferred carrier gas as this can minimise fragmentation of the monomer. In some cases, in particular where they not already present on the substrate, for example as a result of a prior spraying or electro-deposition process, or as a result of inclusion of the nanoparticles in the bulk material of the substrate, nanoparticles will be included with the monomer vapour and/or carrier gas. However, if required, even where present, additional nanoparticles may be deposited on the surface as the polymer is deposited. The formation of the polymeric material on the surface will have the effect of firmly adhering the nanoparticles to the surface.

When used as a mixture, the relative amounts of the monomer vapour to carrier gas and optionally also nanoparticles is suitably determined in accordance with procedures which are conventional in the art. The amount of monomer added will depend to some extent on the nature of the particular monomer being used, the nature of the substrate being treated, the size of the plasma chamber etc. Generally, in the case of conventional chambers, monomer is delivered in an amount of from 50-250 mg/minute, for example at a rate of from 100-150mg/minute. It will be appreciated however, that the rate will vary depending on the reactor size chosen and the number of substrates required to be processed at once; this in turn depends on considerations such as the annual through-put required and the capital outlay.

Carrier gas such as helium is suitably administered at a constant rate for example at a rate of from 5-90 standard cubic centimetres per minute (sccm), for example from 15-30sccm. In some instances, the ratio of monomer to carrier gas will be in the range of from 100:0 to 1:100, for instance in the range of from 10:0 to 1:100, and in particular about 1:0 to 1:10. The precise ratio selected will be so as to ensure that the flow rate required by the process is achieved.

In some cases, a preliminary continuous power plasma may be struck for example for from 15 seconds to 10 minutes, for example from 2-10 minutes within the chamber. This may act as a surface pre-treatment step, ensuring that the monomer attaches itself readily to the surface, so that as polymerisation occurs, the coating “grows” on the surface. The pre-treatment step may be conducted before monomer is introduced into the chamber, in the presence of only an inert gas.

The plasma is then suitably switched to a pulsed plasma to allow polymerisation to proceed, at least when the monomer is present.

In all cases, a glow discharge is suitably ignited by applying a high frequency voltage, for example at 13.56 MHz. This is applied using electrodes, which may be internal or external to the chamber, but in the case of larger chambers are generally internal.

Suitably the gas, vapour or gas mixture is supplied at a rate of at least 1 standard cubic centimetre per minute (seem) and preferably in the range of from 1 to 100 sccm.

In the case of the monomer vapour, this is suitably supplied at a rate of from 80-300 mg/minute, for example at about 120 mg/minute depending upon the nature of the monomer, the size of the chamber and the surface area of the product during a particular run whilst the pulsed voltage is applied. It may however, be more appropriate for industrial scale use to have a fixed total monomer delivery that will vary with respect to the defined process time and will also depend on the nature of the monomer and the technical effect required.

Gases or vapours may be delivered into the plasma chamber using any conventional method. For example, they may be drawn, injected or pumped into the plasma region. In particular, where a plasma chamber is used, gases or vapours may be drawn into the chamber as a result of a reduction in the pressure within the chamber, caused by use of an evacuating pump, or they may be pumped, sprayed, dripped, electrostatically ionised or injected into the chamber as is common in liquid handling.

Polymerisation is suitably effected using vapours of compounds for example of formula (I), which are maintained at pressures of from 0.1 to 400 mtorr, suitably at about 10-100 mtorr.

The applied fields are suitably of power of from 5 to 500 W for example from 20 to 500 W, suitably at about 100 W peak power, applied as a continuous or pulsed field. Where used, pulses are suitably applied in a sequence which yields very low average powers, for example in a sequence in which the ratio of the time on: time off is in the range of from 1:500 to 1:1500. Particular examples of such sequence are sequences where power is on for 20-50 μs, for example about 30 μs, and off for from 1000 μs to 30000 μs, in particular about 20000 μs. Typical average powers obtained in this way are 0.01 W.

The fields are suitably applied from 30 seconds to 90 minutes, preferably from 5 to 60 minutes, depending upon the nature of the compound of formula (I) and the substrate.

Suitably a plasma chamber used is of sufficient volume to accommodate multiple substrates.

A particularly suitable apparatus and method for producing substrates in accordance with the invention is described in WO2005/089961, the content of which is hereby incorporated by reference.

In particular, when using high volume chambers of this type, the plasma is created with a voltage as a pulsed field, at an average power of from 0.001 to 500 W/m³, for example at from 0.001 to 100 W/m³ and suitably at from 0.005 to 0.5 W/m³.

These conditions are particularly suitable for depositing good quality uniform coatings, in large chambers, for example in chambers where the plasma zone has a volume of greater than 500 cm³, for instance 0.1 m³ or more, such as from 0.5 m³-10 m³ and suitably at about 1 m³. The layers formed in this way have good mechanical strength.

The dimensions of the chamber will be selected so as to accommodate the particular substrate or batch of substrates being treated. For instance, generally cuboid chambers may be suitable for a wide range of applications, but if necessary, elongate or rectangular chambers may be constructed or indeed cylindrical, or of any other suitable shape.

The chamber may be a sealable container, to allow for batch processes, or it may comprise inlets and outlets for the substrates, to allow it to be utilised in a continuous process as an in-line system. In particular in the latter case, the pressure conditions necessary for creating a plasma discharge within the chamber are maintained using high volume pumps, as is conventional for example in a device with a “whistling leak”. However it will also be possible to process substrates at atmospheric pressure, or close to, negating the need for “whistling leaks”.

Substrates that may be used in the method of the invention are many. They include for example fabrics or the yarns or fibres used in the preparation of fabrics. Other substrates may include finished garments or items of clothing, in particular shoes, including trainers and sports shoes as well as high fashion shoes, for example the fashion accessories described in WO2007/083124. In addition, the substrates may comprise rigid materials such as polymeric materials, metals, glass, wood, stone, composites, concrete, brick or other construction materials, where a very high degree of liquid repellency may be desirable. The rigid materials may be intended for use in the production of consumer goods, or these goods may already be formed. These may include for example electrical or electronic devices for example as described in WO2007/083122. These include to small portable electronic equipment such as mobile phones, pagers, radios, hearing aids, laptop, notebook, palmtop computers, personal digital assistants (PDAs), outdoor lighting systems, radio antenna and other forms of communication equipment, desktop devices such as keyboards, or instrumentation for instance used in control rooms, devices which are used in sound reproduction and which utilise transducers such as loudspeakers, microphones, ringers and buzzers as well as components thereof such as printed circuit boards (PCBs), transistors, resistors, electronic components, semi-conductor chips and also the membranes or diaphragms used in the sound devices. In particular however, the coating is applied to the outer surface of a fully assembled device, for example the fully assembled mobile phone, or microphone. In such cases, the polymer layer will be applied to, for example an outer casing or foam cover, as well as any exposed components such as control buttons or switches, so as to prevent any liquid reaching the components within.

The applicants have found that the polymer layer forms across the entire surface of the device, including where the device includes different substrate materials, such as a combination of different plastics (including foamed plastic), metals and/or glass surfaces, and surprisingly therefore, the entire device is made liquid repellent. Even where these are not in a water-tight relationship, for example push buttons on a mobile phone which are not fused to the surrounding casing, the polymer layer deposited in this way is sufficiently repellent to prevent liquids penetrating the device around the edge of the buttons into the device. Thus it has been found that mobile phones for example, which are generally very sensitive to liquid damage, can be fully immersed in water after the treatment of the invention, without any lasting harm.

As the coating is carried out without requiring immersion in any liquids, there is no risk to the operation of the device as a result of exposure to this procedure.

Furthermore, the substrates may comprise laboratory consumables, as described in WO 2007083121 or microfluidics devices as described in WO 2008053150. Such substrates include pipette tips, filtration membranes, microplates (including 96 well plates), immunoassay products (such as lateral flow devices), centrifuge tubes (including microcentrifuge tubes), microtubes, specimen tubes, test tubes, blood collection tubes, flat based tubes, aseptically produced containers, general labware, burettes, curvettes, needles, hypodermic syringes, sample vials/bottles, screw cap containers, weighing bottles as well as microfluidic or nanofluidic devices that are miniaturized devices with chambers and tunnels for the containment and flow of fluids.

Filtration membranes and media including woven and non-woven membranes may also comprise substrates for use in the context of the invention.

Thus the substrates themselves may comprise a wide variety of materials including natural or synthetic fibres or polymers, metals, glass and polymers such as thermosetting resins, thermoplastic resins polyolefins, acetals, polyainidic resins, acrylic resins (PMMA), hydrocarbons or fluorocarbons such as polyethylene (PE), polypropylene (PP), polymethylpentene (PMP or TPX®), polystyrene (PS), polyvinyl chloride (PVC), polyoxymethylene (POM), nylon (PA6), polycarbonates (PC), polytetrafluoroethylene (PTFE), tetrafluoroethylene-perfluoropropylene (FEP), perfluoroalkoxy (PFA), polyvinylidene fluoride (PVDF), ethylene-tetrafluorethylene (ETFE) and ethylene-cholortrifluoroethylene (E-CTFE).

Novel substrates obtained using the methods of the invention as described above form a further aspect of the invention.

The invention will now be particularly described by way of example.

### EXAMPLE 1

Substrates such as fabric samples for coating are placed into a plasma chamber with a processing volume of ˜300 litres. The chamber is connected to supplies of the required gases and or vapours, via a mass flow controller and/or liquid mass flow meter and a mixing injector or monomer reservoir as appropriate.

The chamber is evacuated to between 3 and 10 mtorr base pressure before allowing helium into the chamber at 20 sccm until a pressure of 80 mtorr was reached. A continuous power plasma is then struck for 4 minutes using RF at 13.56 MHz at 300 W.

After this period, 1H,1H,2H,2H-heptadecafluorodecylacylate (CAS #27905-45-9) of formula

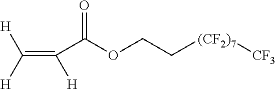

containing silver nanoparticles (1-10 nm) at a concentration of 1.5 mg/ml is brought into the chamber at a rate of 120 milligrams per minute and the plasma switched to a pulsed plasma at 30 microseconds on-time and 20 milliseconds off-time at a peak power of 100 W for 40 minutes. On completion of the 40 minutes the plasma power is turned off along with the processing gases and vapours and the chamber evacuated back down to base pressure. The chamber is then vented to atmospheric pressure and the substrates removed.

Highly water and oil repellent surfaces are achieved, which are abrasion and wash resistant.

1. A method for forming a liquid repellent surface on a substrate, said method comprising applying a combination of nanoparticles and a polymeric material to the substrate in a chamber using ionisation or activation technology.

2. A method as claimed in claim 1 wherein the nanoparticles comprise silver, palladium, gold, silicone, silica, titanium dioxide or polymeric nanoparticles.

3. A method as claimed in claim 1 wherein the nanoparticles have an average diameter of from 1 to 500 nm.

4. A method as claimed in claim 1 wherein the polymeric material is hydrophobic and/or oleophobic.

5. A method as claimed in claim 1, wherein the substrate is selected from fabrics, fibres, clothing, shoes, electronic or electrical devices or components thereof, laboratory consumables, filtration media or membranes or microfluidic devices.

6. A method as claimed in claim 1 wherein in a first step, nanoparticles are disposed on the surface of the substrate in the chamber, and in a subsequent step, the substrate is exposed to ionisation or activation conditions in the presence of a monomer capable of forming said polymeric material under said conditions.

7. A method as claimed in claim 6 wherein the nanoparticles are disposed on the substrate surface using ionisation or activation technology.

8. A method as claimed in claim 1 which method comprises exposing a substrate to ionisation or activation conditions in the presence of a monomer capable of forming a polymer under said conditions and nanoparticles so that the nanoparticles and the polymeric material are formed in a single step.

9. A method as claimed in claim 8 wherein the nanoparticles are dispersed in the monomer supplied to the substrate.

10. A method as claimed in claim 1 wherein the ionisation or activation conditions comprise plasma processing.

11. A method as claimed in claim 10 wherein the plasma is pulsed.

12. A method as claimed in claim 1 wherein the polymeric material is formed by polymerisation of a monomer which is selected from a compound of formula (I) 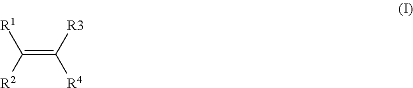
where R¹, R² and R³ are independently selected from hydrogen, halo, alkyl, haloalkyl or aryl optionally substituted by halo; and R⁴ is a group —X—R⁵ where R⁵ is halo, an alkyl or haloalkyl group and X is a bond; a group of formula —C(O)O—, a group of formula —C(O)O(CH₂)ₙY— where n is an integer of from 1 to 10 and Y is a sulphonamide group; or a group —(O)ₚR⁶(O)_{q}(CH₂)ₜ— where R⁶ is aryl optionally substituted by halo, p is 0 or 1, q is 0 or 1 and t is 0 or an integer of from 1 to 10, provided that where q is 1, t is other than 0;
a compound of formula (V) 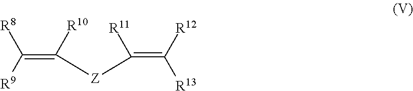
where R⁸, R⁹, R¹⁰, R¹¹, R¹², and R¹³ are all independently selected from hydrogen, halo, alkyl, haloalkyl or aryl optionally substituted by halo; and Z is a bridging group; a compound of formula (VII) 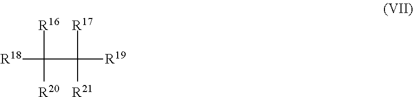
where R¹⁶, R¹⁷, R¹⁸, R¹⁹ and R²⁰ are independently selected from hydrogen, halogen, alkyl, haloalkyl or aryl optionally substituted by halo; and R²¹ is a group X—R²² where R²² is an alkyl or haloalkyl group and X is a bond or a group of formula —C(O)O(CH₂)ₓY— where x is an integer of from 1 to 10 and Y is a bond or a sulphonamide group; or a group —(O)ₚR²³(O)ₛ(CH₂)ₜ— where R²³ is aryl optionally substituted by halo, p is 0 or 1, s is 0 or 1 and t is 0 or an integer of from 1 to 10, provided that where s is 1, t is other than 0;
a compound of formula (VIII)
R²⁴—C≡C—X¹—R²⁵ (VIII)
where R²⁴ is hydrogen, alkyl, cycloalkyl, haloalkyl or aryl optionally substituted by halo; X¹ is a bond or a bridging group; and R²⁵ is an alkyl, cycloalkyl or aryl group optionally substituted by halogen; or
a compound of formula (XIV)
R²⁸C≡C(CH₂)ₙSIR²⁹R³⁰R³¹ (XIV)
where R²⁸ is hydrogen, alkyl, cycloalkyl, haloalkyl or aryl optionally substituted by halo, R²⁹, R³⁰ and R³¹ are independently selected from alkyl or alkoxy, in particular C₁₋₆ alkyl or alkoxy.

13. A substrate having a combination of nanoparticles and polymeric material, deposited on the surface thereof using ionisation or activation technology, so as to form a liquid repellent surface.
